(19) United States
(12) Patent Application Publication
(10) Pub. No.: US 2012/0177935 A1
(43) Pub. Date: Jul. 12, 2012

(54) Process for Producing an Ultra-Low-Carbon Steel Slab, Strip or Sheet

(76) Inventors: Ben Richards, IJsselstein (NL); Wouter Karel Tiekink, Heemskerk (NL); Maarten Arie De Haas, Heerhugowaard (NL)

(21) Appl. No.: 13/387,338

(22) PCT Filed: Jul. 20, 2010
(86) PCT No.: PCT/EP2010/004429

§ 371 Date: Feb. 29, 2012

(30) Foreign Application Priority Data
Jul. 30, 2009 (EP) 09009867.4
Nov. 24, 2009 (EP) 09014611.9
Apr. 27, 2010 (EP) 10004418.9

(51) Int. Cl. B32B 15/04; C21D 11/00; C22C 38/00; B22D 11/00

(52) U.S. Cl. 428/457; 164/451; 148/508; 420/8; 420/87

(57) ABSTRACT

Process producing ultra low carbon steel strip or sheet including producing a vacuum-degassed steel melt in a steelmaking step including a ladle treatment containing, by weight, at most 0.008% carbon; at most 0.008% nitrogen; at most 0.20% phosphorus; at most 0.020% sulphur; balance iron and inevitable impurities. Melt target oxygen content at end of ladle treatment of the melt is obtained by measuring the melt actual oxygen content followed by adding a suitable amount of aluminium in a suitable form to the melt to bind oxygen. Melt target oxygen content at the end of the ladle treatment is at most 80 ppm. Casting steel thus produced in a continuous casting process to form slab or strip. The process provides slab, strip or sheet of ultra low carbon steel containing at most 0.002% of acid soluble aluminium and at most 0.003% silicon and total oxygen content at most 100 ppm.

The present invention relates to a process for producing an ultra low carbon steel slab, strip or sheet, and to a slab, strip or sheet produced thereby.

Canmaking via the DWI (Drawing and Wall Ironing) or DRD (Draw and Redrawing) process takes place at high speed and involves severe plastic strain. The steel therefore needs to be of the highest quality and a very low level of non-metallic inclusions is essential to the efficient operation of these processes. However, care must be taken to avoid an excessively large ferrite grain which can give rise to an orange peel effect and a poor surface for lacquering. DWI cans are, for instance, used for beer and soft-drinks, pet foods and human foodware, but also for battery cans. DRD cans are, for instance, used for pet foods and human foodware. Low levels of non-metallic inclusions are also very important for electrical steels.

Steels currently in production rely on the use of small precipitates to prevent the grains from becoming too large. However, the disadvantage is that the formability may be adversely affected by the presence of the precipitates. Also, the presence of precipitates adversely affects the magnetic properties for transformer steels because the precipitates hamper the motion of magnetic domain walls.

It is an object of the invention to provide a process for producing an ultra-low-carbon steel strip or sheet suitable for can making.

It is also an object of the invention to provide a process for producing an ultra-low-carbon steel strip or sheet suitable as an electrical or transformer steel.

According to the first aspect a process is provided for producing an ultra-low-carbon steel slab or strip, said process comprising:
producing a vacuum-degassed steel melt in a steelmaking step comprising
   a ladle treatment comprising, by weight,
      at most 0.008% carbon,
      at most 0.008% nitrogen,
      at most 0.20% phosphorus,
      at most 0.020% sulphur,
      and balance iron and inevitable impurities,
wherein a target oxygen content of the melt at the end of the ladle treatment of the melt is obtained by measuring the actual oxygen content of the melt followed by adding a suitable amount of aluminium in a suitable form to the melt to bind oxygen wherein the target oxygen activity or dissolved oxygen content of the melt at the end of the ladle treatment is at most 80 ppm;
casting the steel thus produced in a continuous casting process to form a slab or strip;
wherein said process provides a slab, strip or sheet of ultra-low-carbon steel comprising at most 0.002% of acid soluble aluminium and at most 0.004% silicon and a total oxygen content of at most 120 ppm.

With the process according to the invention a steel slab or strip can be produced having very clean grain boundaries. As a result, the recrystallisation temperature of the steel is much lower than conventional ultra-low carbon steels. This phenomenon is attributed to the extremely low levels of silicon and acid soluble aluminium in the final steel strip or sheet and the presence of finely dispersed manganese and/or iron oxide particles. As a result of the low recrystallisation temperature of the steel the annealing temperatures can be reduced as well, leading to a more economical process as well as a reduced tendency for grain growth in the product. The reduced annealing temperatures also prevent sticking in batch annealing processes and reduce the risk of rupture in continuous annealing. A further advantage of the very clean grain boundaries is the strongly reduced susceptibility to corrosion on the grain boundaries. This is especially relevant for the application of the steel in the production of battery cases. The coating systems used in the production of batteries may be leaner (e.g. thinner coating layers or fewer coating layers) when using a substrate with a better corrosion resistance. The very clean steels are also beneficial for transformer or other electrical applications. For transformer steels punchability is important, hence the phosphorous content of 0.2%. A suitable maximum value for phosphorous is 0.15%. For producing a mild cold-rolled steel from the slab or strip, the phosphorous content should be selected to be not greater than 0.025wt %, preferably at most 0.020%. A suitable maximum for silicon is 0.003%.

The essential difference with the conventional process for producing an ultra-low-carbon steel strip or sheet is that the ladle treatment of the melt during the vacuum-degassing step, e.g. in an RH-process, does not target a removal of the oxygen by killing it by adding excess aluminium to form alumina particles, but a process wherein the oxygen content of the melt is monitored and controlled, and a dedicated amount of aluminium is added so as to avoid the addition of excess aluminium to the melt which would be present in the final steel as acid soluble aluminium (i.e. in the form of metallic aluminium, not as alumina). It is therefore not an aluminium killed steel in the sense of EN10130. The alumina formed during the ladle treatment floats to the slag and the level of excess aluminium, if any, is quickly reduced as a result of the so-called Aluminium fade. The addition of the precise amount of aluminium ensures that all alumina formed in the ladle treatment is removed from the melt prior to solidification during continuous casting, so that the resulting steel contains substantially no aluminium oxide. The degassing of the molten steel may be made by any conventional methods such as the RH method or the RH-OB method. The oxygen content of the liquid steel may be measured using expendable oxygen sensors to measure the melt's oxygen activity.

The absence of metallic aluminium prevents the formation of aluminium-nitride precipitates at later stages of the process and therefore provides clean grain boundaries. Moreover, the absence of AlN also prevents many problems associated with the dissolution and precipitation characteristics of AlN in the hot strip process such as inhomogeneities of the microstructure and properties over length and width of the strip as a result of the difference in thermal path of different positions of the hot rolled strip in coiled form. There is no need to dissolve the AlN in the reheating furnace of a hot strip mill so a lower furnace temperature can be used, nor is there a need to use a high coiling temperature to allow the AlN to precipitate in the coil. This in turn leads to an improved pickling ability. The chemistry of the slab or strip results in the formation of finely dispersed oxides, comprising mainly manganese oxides. Of these inclusions, relatively large size inclusions act as nuclei for the recrystallisation during annealing of cold-rolled steel, while relatively small size inclusions may act to become appropriate barriers with respect to grain coarsening caused after the recrystallisation to thereby control the grain size of the steel.

The carbon content of the steel melt is limited to at most 0.008% because when a higher carbon content is used, the carbon forms carbon monoxide in the manufacturing stage during which the steel is molten, and that CO in turn remains as blow-hole defects in the solidified steel. Moreover, the boiling effect may cause operational problems during casting. It should be noted that the silicon in the solidified steel may be present as silicon oxide and/or as metallic silicon.

During casting very little and preferably no Al is left in the steel, and as a consequence the Si pick-up, which normally occurs according to the following reaction Alₛₜₑₑₗ+SiO₂→Al₂O₃+Siₛₜₑₑₗ) does not occur due to the low Al-content.

A conventional process for producing an aluminium killed ultra-low-carbon steel strip or sheet results in an oxygen activity or dissolved oxygen content at the end of the ladle treatment of the melt, i.e. immediately prior to casting, of about 3 to 5 ppm. In the process according to the invention the target oxygen content of the melt at the end of the ladle treatment of the melt is at least 20 ppm. It should be noted that the oxygen content of the melt may increase during the time between the end of the ladle treatment and the casting step. The total oxygen content of the slab or strip may therefore be at most 120 ppm, preferably at most 100 ppm. The total oxygen content comprises oxides as well as oxygen in solution.

In an embodiment the target oxygen content of the melt at the end of the ladle treatment of the melt is at least 10 ppm. This minimum values ensures that sufficient manganese oxides are formed. To avoid too many large oxides it is preferable that the target oxygen content is at most 60 ppm. The inventors found that a target oxygen content at the end of the ladle treatment between 10 and 40 ppm provided a good compromise. A suitable minimum target oxygen content of the melt at the end of the ladle treatment of the melt is at least 20 ppm. It is believed that the relatively high oxygen content of the steel melt prior to casting results in a low viscosity as a result of the high oxygen potential of the melt.

By steering the process on the oxygen content, rather than on the aluminium content the amount of acid soluble aluminium and the amount of silicon is as low as possible. It is preferable that the strip or sheet of ultra-low-carbon steel produced according to the invention comprises at most 0.001% of acid soluble aluminium and/or at most 0.002% silicon. Even more preferable the silicon content is at most 0.001%. Ideally, there is no acid soluble aluminium and no silicon in the solidified steel.

In an embodiment a process is provided for producing a slab or strip wherein the slab, strip or sheet comprises
at most 0.006% carbon,
between 0.05 and 0.35% manganese,
at most 0.006% nitrogen,
at most 0.025% phosphorus,
at most 0.020% sulphur,
at most 40 ppm B
at most 0.005% titanium, at most 0.005% niobium, at most 0.005% zirconium, at most 0.005% vanadium
a total amount of the elements copper, nickel, chromium, tin and molybdenum of at most 0.10%,
   and balance iron and inevitable impurities.

This process produces a slab or strip suitable for producing a mild cold-rolled steel for applications such as DWI- or DRD-canmaking. Depending on whether the steel is alloyed with boron or not, the process provides a substantially boron free strip or sheet of ultra-low-carbon steel having a low recrystallisation temperature of between 600 and 630° C. or a boron containing strip or sheet of ultra-low-carbon steel having a recrystallisation temperature of between 660 and 690° C. It should be noted however that the recrystallisation temperature is also dependent on the annealing treatment and the amount of deformation to which the steel was subjected.

In an embodiment the steel slab or strip comprises
at most 5 ppm B, or wherein the steel comprises between 10 and 30 ppm B and/or
at most 0.004% carbon, preferably at most 0.003%, 0.0028%, 0.0025% or even 0.002% carbon and/or
at most 0.005% nitrogen, preferably at most 0.004 and/or more preferably between 0.0012 and 0.0030% nitrogen. A suitable upper boundary for nitrogen is 0.0030%.

Preferably the boron free steel comprises at most 1 ppm B. Preferably the Boron containing steel comprises between 10 and 25 ppm B, preferably between 12 and 22 ppm B. The carbon content of at most 0.004% carbon, preferably at most 0.002% is intended to minimise the risk of CO-formation, carbide formation and carbon ageing issues.

Preferably, the sulphur content is at most 0.010%, more preferably at most 0.005%.

In an embodiment a process is provided wherein the steel slab or strip is subjected to
hot-rolling the slab at a temperature above Ar3 to obtain a hot-rolled strip;
coiling the hot-rolled strip;
cold-rolling the hot-rolled strip with a cold rolling reduction of between 40 and 95% to obtain an intermediate cold-rolled strip;
annealing the intermediate cold-rolled strip;
optionally subjecting the intermediate cold-rolled strip to a second cold rolling down to a final sheet thickness;
optionally cutting the strip into sheets or blanks;

The optional second cold rolling may be a conventional temper rolling step, preferably at a reduction of between 0.5 to 10%. However, the second cold rolling may also involve a substantially higher cold rolling reduction of preferably between 5 and 50% to produce a steel with a higher yield strength. The slab may be heated and hot-rolled in ordinary way. Alternatively, the warm slab may be heated or the hot slab may be hot-rolled directly. In order to save energy and, hence, to achieve a greater economy, the preheating of the steel prior to the hot-rolling is made at a relatively low temperature of 1150° C. or lower, although the invention does not exclude the use of higher preheating temperatures.

In an embodiment the intermediate cold-rolled steel strip or sheet is subjected to a recrystallisation treatment by continuously annealing at a minimum temperature of 600° C. or 620° C., preferably between 620° C. and 720° C., more preferably between 630° C. and 700° C., or by batch-annealing between 550° C. and 680° C., preferably between 600° C. and 680° C.

One of the characteristic features of the invention is that the coiling temperature is limited neither to high temperature nor to low temperature. Namely, according to the invention, the steel may be coiled up at temperatures between 500 and 700° C. When the coiling temperature is higher than the above mentioned temperature range, the pickling is impeded due to a too large scale thickness. In an embodiment the coiling temperature is between 530 and 700° C., preferably between 550 and 650° C. A suitable minimum coiling temperature is 570° C., and a suitable maximum is 640° C. The lower coiling temperature can be chosen because there is no AlN-precipitation to be controlled by it. As a result the oxide layer on the strip is thinner and easier to remove by pickling.

In an embodiment the hot-rolled sheet has a thickness of between 2.0 and 3.5 mm, the hot-rolled strip is cold rolled with a reduction ratio of between 85 and 96%, preferably between 85 and 95%, and wherein the second cold rolling reduction is between 0.5 and 10%. Preferably the reduction ratio is between 87 and 93%. For double cold rolled steels the second cold rolling reduction is preferably between 5 and 50%

In an embodiment the manganese content is between 0.10 and 0.35%. Suitable maximum values for P and S in the solidified steel are 0.020 and 0.010 respectively.

In an embodiment the ultra-low-carbon steel strip or sheet according to the invention comprises at most 0.001% titanium and at most 0.001% niobium weight, and at most 0.001% zirconium by weight. It is important that the amount of elements causing deoxidation are minimised. Hence the silicon content of the melt is preferably minimised to 0.030 or even 0.020%. Ti, Nb, Zr, and V also cause deoxidation, and hence their value is preferably below 0.005 and more preferably below 0.001%. Other deoxidising elements such as REM are also preferably as low as possible.

According to a second aspect, an ultra-low-carbon steel slab, strip or sheet produced according to the process of the invention as described hereinabove is provided.

In an embodiment the ultra-low-carbon steel strip or sheet according the invention has an average grain size of between 8 and 12 ASTM, preferably between 9 and 11 ASTM and/or an r-value of at least 1.4, preferably of at least 1.6.

In an embodiment the ultra-low-carbon steel strip or sheet according to the invention has a plane anisotropy coefficient value (Δr) of between −0.2 and 0.2.

The steel may be coated with a metallic and/or polymer coating system.

According to a third aspect the ultra-low carbon steel sheet according to the invention is used in packaging applications such as cans for packaging foodstuff or beverages or in packaging applications such as batteries or as electrical steels for applications such as electromagnets.

In an embodiment the ultra-low carbon steel sheet according to the invention is used as enamelling steel. The presence of the finely dispersed manganese oxide particles and the clean matrix results in an ability to store hydrogen during the enamelling process and avoids surface defects like fish-scale on the enamelled product.

The invention will now be illustrated by means of non-limitative examples. Continuously cast slabs were produced of the steel grades listed in table 1.

TABLE 1
composition in 1/1000 wt. % except C, N and B in ppm

| ID | C | Mn | P | S | Si | Al | Alₛₒₗ | N | Cu | Cr | Nb | Ni | V | Mo | Sn | B | Ti |
|---|---|---|---|---|---|---|---|---|---|---|---|---|---|---|---|---|---|
| 2AA | 15 | 175 | 12 | 8 | 0 | 1 | <1 | 18 | 22 | 23 | 0 | 20 | 1 | 3 | 3 | 0 | 1 |
| 2AC | 20 | 181 | 11 | 9 | 0 | 3 | <1 | 19 | 23 | 20 | 0 | 18 | 0 | 1 | 3 | 15 | 1 |

Steel 2AA is a boron free steel and steel 2AC is a boron containing steel in accordance with the invention. The aluminium acid soluble content (Alₐₛ) is below 0.001 wt % in both cases, and the measurement of the silicon content yielded values close to 0. Total oxygen content in the slab was 98 ppm for both steels. The hot rolled strip was coiled at 590° C. and were subsequently cold rolled with a 90% reduction. The recrystallisation temperature of the steels were 625 and 675° C. respectively for continuous annealing at a line speed of 500 m/min. These values are significantly lower than those for conventional ultra low carbon steels with higher aluminium and silicon contents. After cold rolling the 2AA material was continuously annealed at 660 and 680° C. and provided a fully recrystallised structure with a somewhat larger grain after annealing at 680° C. The 2AC material was continuously annealed at 680° C. A second cold rolling was performed at 1 and 6%. Batch annealing at 650° C. also results in a fully recrystallised structure.

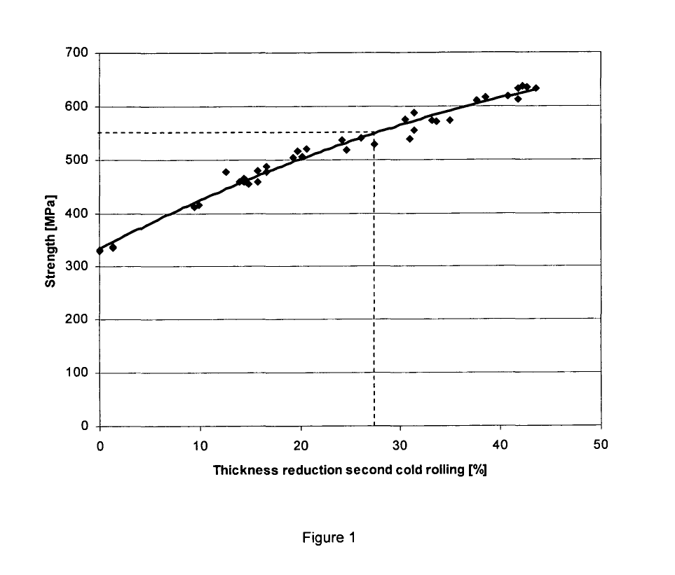

Processing of steel 2AA after recrystallisation resulted in the work hardening curve as shown in FIG. 1. This clearly demonstrates that a DR550 can be obtained with 28% thickness reduction (i.e. 38% elongation) during the second cold rolling.

1. A process for producing ultra-low-carbon steel strip or sheet, said process comprising:
producing a vacuum-degassed steel melt in a steelmaking step comprising a ladle treatment comprising, by weight,
at most 0.003% carbon,
at most 0.004% nitrogen,
at most 0.20% phosphorus,
at most 0.020% sulphur,
and balance iron and inevitable impurities,
wherein a target oxygen content of the melt at the end of the ladle treatment of the melt is obtained by measuring the actual oxygen content of the melt followed by adding a suitable amount of aluminium in a suitable form to the melt to bind oxygen wherein the target oxygen activity or dissolved oxygen content of the melt at the end of the ladle treatment is at most 80 ppm;
casting the steel thus produced in a continuous casting process to form a slab or strip;
wherein said process provides a slab, strip or sheet of ultra-low-carbon steel comprising at most 0.002% of acid soluble aluminium and at most 0.004% silicon and a total oxygen content of at most 120 ppm.

2. The process according to claim 1, wherein the steel melt comprises 0.002% carbon and/or at most 0.003% silicon and/or wherein the slab, strip or sheet comprises a total oxygen content of at most 100 ppm.

3. The process according to claim 1, wherein the target oxygen content of the melt at the end of the ladle treatment of the melt is at least 10 ppm.

4. The process according to claim 1 , wherein the target oxygen content of the melt at the end of the ladle treatment of the melt is at most 60 ppm, preferably at most 40 ppm.

5. The process according to claim 1, wherein the process provides a strip or sheet of ultra-low-carbon steel comprising at most 0.001% of acid soluble aluminium and/or at most 0.002% silicon.

6. The process according to claim 1, wherein the slab, strip or sheet comprises
at most 0.003% carbon,
between 0.05 and 0.35% manganese,
at most 0.004% nitrogen,
at most 0.025% phosphorus,
at most 0.020% sulphur,
at most 40 ppm B
at most 0.005% titanium, at most 0.005% niobium, at most 0.005% zirconium, at most 0.005% vanadium
a total amount of the elements copper, nickel, chromium, tin and molybdenum of at most 0.10%,
and balance iron and inevitable impurities.

7. The process according to claim 1, wherein the steel slab or strip comprises
at most 5 ppm B, or wherein the steel comprises between 10 and 30 ppm B and/or
at most 0.002% carbon and/or
between 0.0012 and 0.0030% nitrogen.

8. (canceled)

9. The process according to claim 1, wherein the intermediate cold-rolled steel strip or sheet is subjected to a recrystallisation recrystallization treatment by continuously annealing between 600° C. and 720° C.

10. The process according to claim 1, wherein the coiling temperature is between 530 and 700° C.

11. The process according to claim 1, wherein the hot-rolled strip has a thickness of between 2.0 and 3.5 mm, the hot-rolled strip is cold rolled with a reduction ratio of between 85 and 96%, and wherein the second cold rolling reduction is between 0.5 and 10%.

12. An ultra-low-carbon steel slab, strip or sheet produced by the process of claim 1.

13. The ultra-low-carbon steel strip or sheet according to claim 12 having an average grain size of between 8 and 12 ASTM, preferably between 9 and 11 ASTM,
and/or an r-value of at least 1.4, preferably at least 1.6,
and/or wherein the plane anisotropy coefficient (Δr) is between −0.2 and 0.2.

14. A product comprising the ultra-low carbon steel sheet according to claim 12, selected from at least one member of the group consisting of:
cans for packaging foodstuff or beverages, battery cans, and
electrical or transformer steels in electromagnets or transformers.

15. A method comprising enamelling the ultra-low carbon steel sheet according to claim 12.

16. The process according to claim 1, wherein the target oxygen content of the melt at the end of the ladle treatment of the melt is at most 40 ppm.

17. The process according to claim 1, wherein the steel slab or strip comprises
hot-rolling the slab at a temperature above Ar3 to obtain a hot-rolled strip;
coiling the hot-rolled strip;
cold-rolling the hot-rolled strip with a cold rolling reduction of between 40 and 96% to obtain an intermediate cold-rolled strip;
annealing the intermediate cold-rolled strip;
optionally subjecting the intermediate cold-rolled strip to a second cold rolling down to a final sheet thickness;
optionally cutting the strip into sheets or blanks.

18. The process according to claim 1, wherein the intermediate cold-rolled steel strip or sheet is subjected to a recrystallization treatment by batch-annealing between 550° C. and 680° C.

19. The process according to claim 1, wherein the coiling temperature is between 550 and 650° C.

20. The ultra-low-carbon steel strip or sheet according to claim 12 having an average grain size of between 9 and 11 ASTM, and/or an r-value of at least 1.6,
and/or wherein the plane anisotropy coefficient (Δr) is between −0.2 and 0.2.
